(19) United States
(12) Patent Application Publication
(10) Pub. No.: US 2018/0347249 A1
(43) Pub. Date: Dec. 6, 2018

(54) RAIL TRANSIT DOOR ISOLATION LOCK

(71) Applicant: Westinghouse Air Brake Technologies Corporation, Wilmerding, PA (US)

(72) Inventor: Gunneet Singh, Montreal (CA)

(21) Appl. No.: 15/610,005

(22) Filed: May 31, 2017

(51) Int. Cl. E05F 15/40; E05B 81/90; E05B 83/04

(52) U.S. Cl. CPC E05F 15/40; E05Y 2900/51; E05B 83/04; E05B 81/90

(57) ABSTRACT

An isolation lock mechanism for a transit vehicle door includes a lock bracket configured to be connected to the transit vehicle door; a lock pin configured to be moved between an engaged position in which the lock pin is extended to engage the lock bracket and a disengaged position in which the lock pin is withdrawn from the lock bracket; and a linkage assembly connected to the lock pin and configured to be actuated to move the lock pin between the engaged position and the disengaged position. The linkage assembly is configured to be connected to an emergency release device such that operation of the emergency release device to unlock the transit vehicle door also actuates the linkage assembly to move the lock pin from the engaged position to the disengaged position.

### BACKGROUND OF THE INVENTION

### Field of the Invention

The present invention relates generally to an isolation lock mechanism for a transit vehicle door and, in particular, to an isolation lock mechanism that is operated in conjunction with a door operator system.

### Description of Related Art

Isolation lock mechanisms are provided in door systems for transit vehicles to cause the vehicle doors to be locked in a closed position when the door system is damaged and/or is undergoing maintenance.

Current standards for public transit vehicles, such as the North American APTA Standard PR-M-S-18-10, require that the emergency release for opening the doors of a transit vehicle also disengages any engaged isolation lock when the release is pulled. The maximum allowable pull force for actuating the emergency release is dictated by applicable standards.

### SUMMARY OF THE INVENTION

According to an example of the present disclosure, an isolation lock mechanism for a door system of a transit vehicle is provided. The isolation lock mechanism is operated in conjunction with the door operator for the door system such that actuation of an emergency release to open the door or doors also disengages the isolation lock and is compatible with door operators that incorporate an overcenter locking mechanism. The isolation lock mechanism requires a low actuation force to be applied to the emergency release to unlock the mechanism while also unlocking the main lock, such as an overcenter lock, of the door. The isolation lock mechanism is simple, compact, and inexpensive to produce. The isolation lock mechanism complies with applicable standards for transit vehicles that require the emergency release to disengage any engaged isolation lock while the release is pulled and with requirements concerning the maximum allowable pull force for disengaging the isolation lock.

According to a particular example of the present disclosure, an isolation lock mechanism for a transit vehicle door is provided. The isolation lock mechanism comprises a lock bracket configured to be connected to the transit vehicle door; a lock pin configured to be moved between an engaged position in which the lock pin is extended to engage the lock bracket and a disengaged position in which the lock pin is withdrawn from the lock bracket; and a linkage assembly connected to the lock pin and configured to be actuated to move the lock pin between the engaged position and the disengaged position. The linkage assembly is configured to be connected to an emergency release device such that operation of the emergency release device actuates the linkage assembly to move the lock pin from the engaged position to the disengaged position while at the same time, it unlocks the door operator lock by pushing on the drive nut.

According to another particular example of the present disclosure, a door assembly for a transit vehicle having a door opening formed in a wall of the transit vehicle is provided. The door assembly comprises at least one door disposed adjacent to the wall; a door operator system configured to move the at least one door along the door opening between open and closed positions; an emergency release device configured to manually unlock the door operator system; and an isolation lock mechanism. The isolation lock mechanism comprises a lock bracket connected to the at least one door; a lock pin configured to be moved between an engaged position in which the lock pin is extended to engage the lock bracket and a disengaged position in which the lock pin is withdrawn from the lock bracket; and a linkage assembly connected to the lock pin and configured to be actuated to move the lock pin between the engaged position and the disengaged position. The linkage assembly is connected to an emergency release device such that operation of the emergency release device actuates the linkage assembly to move the lock pin from the engaged position to the disengaged position while at the same time, it unlocks the door operator lock by pushing on the drive nut.

These and other features and characteristics of the present invention, as well as the methods of operation and functions of the related elements of structures, and the combination of parts and economies of manufacture will become more apparent upon consideration of the following description and with reference to the accompanying drawings, all of which form a part of this specification, wherein like reference numerals designate corresponding parts in the various figures. It is to be expressly understood, however, that the drawings are for the purpose of illustration and description only, and are not intended as a definition of the limits of the invention. As used in the specification and the claims, the singular forms of “a”, “an”, and “the” include plural referents unless the context clearly dictates otherwise.

### BRIEF DESCRIPTION OF THE DRAWINGS

FIG. 1 is a perspective view of a portion of a transit vehicle having an isolation lock mechanism according to an example of the present disclosure;

FIG. 2 is a front perspective view of a door operator system and isolation lock mechanism according to an example of the present disclosure;

FIG. 3 is an enlarged perspective view of a portion of the door operator system and isolation lock mechanism of FIG. 2;

FIG. 4 is a rear perspective view of the door operator system and isolation lock mechanism of FIG. 2;

FIG. 5 is an enlarged rear perspective view of a portion of the door operator system and isolation lock mechanism of FIG. 2;

FIG. 6 is an enlarged perspective view of a portion of the door operator system and isolation lock mechanism of FIG. 2 in an engaged position;

FIG. 7 is another enlarged perspective view of a portion of the door operator system and isolation lock mechanism of FIG. 2 in an engaged position;

FIG. 8 is an enlarged perspective view of a portion of the door operator system and isolation lock mechanism of FIG. 2 in a deactivated state; and

FIG. 9 is another enlarged perspective view of a portion of the door operator system and isolation lock mechanism of FIG. 2 in a deactivated state.

### DETAILED DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

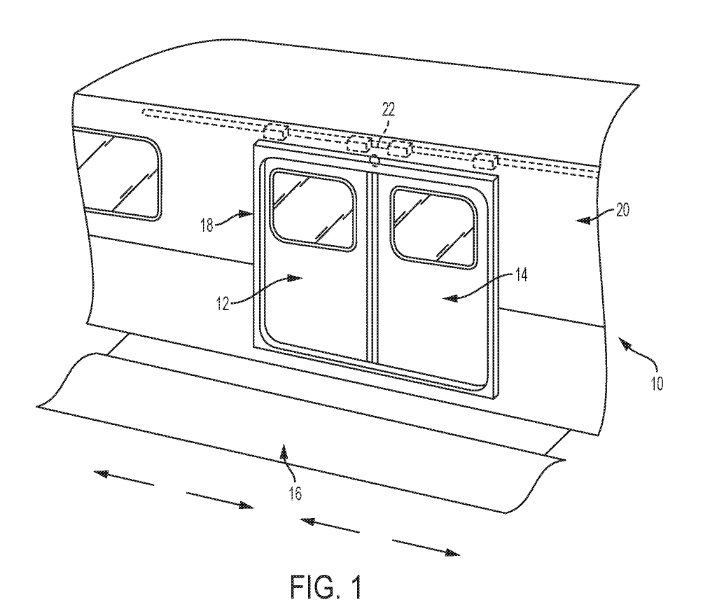

With reference to FIG. 1, a transit vehicle 10, such as a subway car, trolley car, or other rail transit vehicle, or similar vehicle, is shown according to an example of the present disclosure. The vehicle 10 includes a door assembly that includes a pair of outside bi-parting doors 12, 14 and a door operator system 22 according to an example of the present disclosure. As shown, the doors 12, 14 are closed and the transit vehicle 10 is stopped at a platform. The doors 12, 14 cover a passenger portal or opening 18 formed in a wall 20 of the transit vehicle 10. The doors 12, 14 are disposed adjacent to the wall 20 and are slidably suspended from the door operator system 22, which is disposed on the wall 20 above the door opening 18. The door operator system 22 moves the pair of doors 12, 14 in opposing directions along the door opening 18 between open and closed positions.

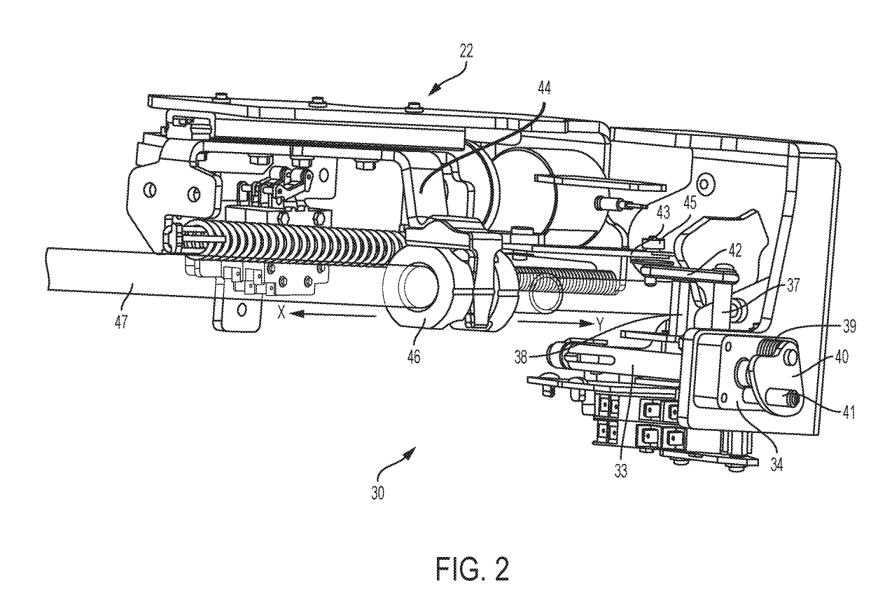

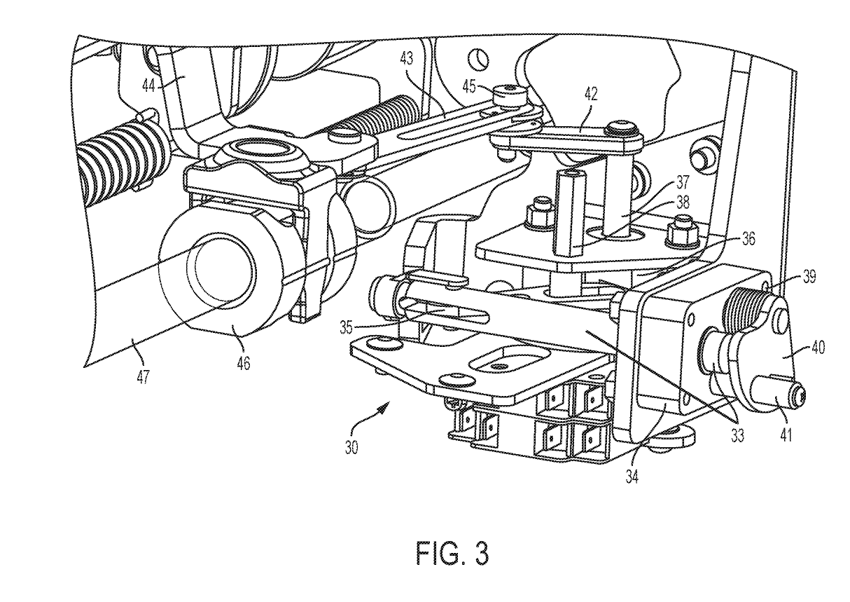

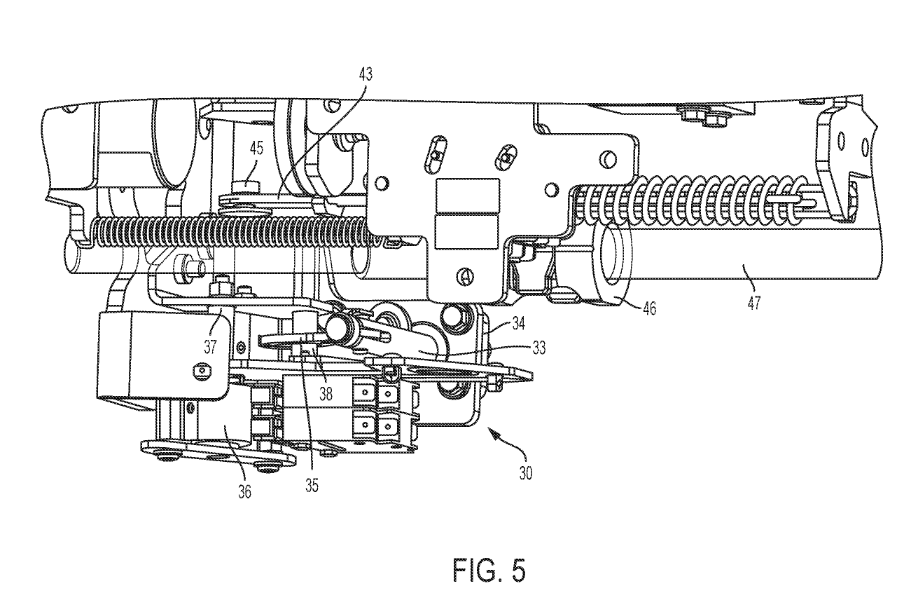

As shown in FIGS. 2-9, the door operator system 22 includes a drive nut 46 movable along a drive shaft 47. The drive nut 46 is connected to the door 12, 14 (connection not shown). An emergency release device 50, which includes a mobile carrier 44 and an emergency release cable 48, is connected to or incorporated into the door operator system 22. While in the closed and locked position, the drive nut 46 of the door operator system 22 makes contact with the mobile carrier 44 of the emergency release device 50. The mobile carrier 44 is movable in the X direction when an emergency release cable 48 of an emergency release device 50 is pulled. With reference to FIGS. 1 and 2, the drive nut 46 is movable along a drive shaft 47 in a first horizontal direction X to unlock the door operator system 22 and to move the door 12, 14 to an open position and in a second horizontal direction Y to lock the door operator system 22 and move the door 12, 14 to a closed position. According to one example of the present disclosure, the door operator system 22 is the same as the door operator system disclosed in Applicant's co-pending International Patent Application No. PCT/US2017/026057, filed on Apr. 5, 2017, which is hereby incorporated by reference in its entirety.

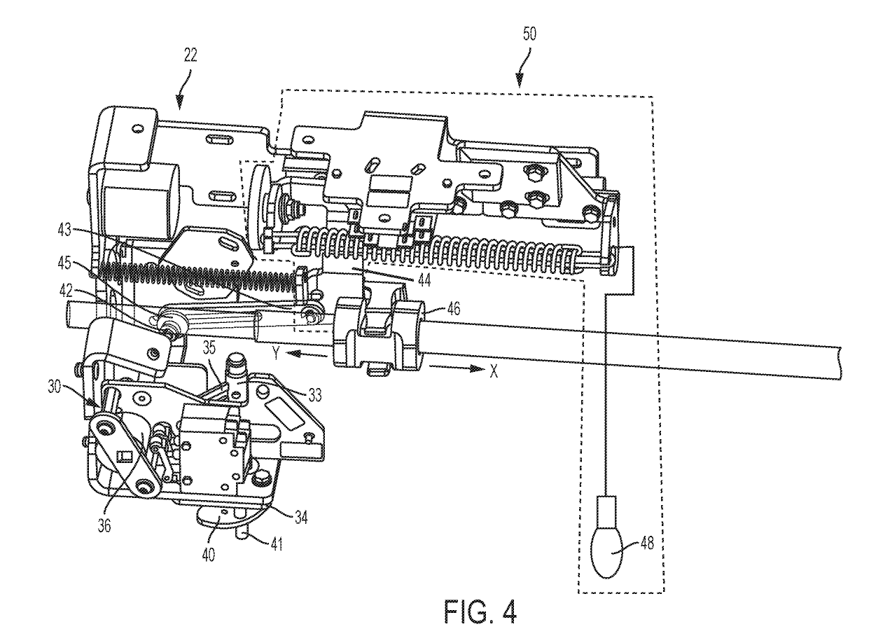

As shown in FIG. 4, the emergency release device 50 is manually actuated by pulling on the emergency release cable 48, which, in turn, causes the mobile carrier 44 to be moved in the X direction. As the mobile carrier 44 moves in the X direction, the mobile carrier 44 contacts and pushes on the drive nut 46 to also move along the drive shaft 47 in the X direction, which unlocks the overcenter locking mechanism of the door operator system 22 and moves the door 12, 14 to the open position.

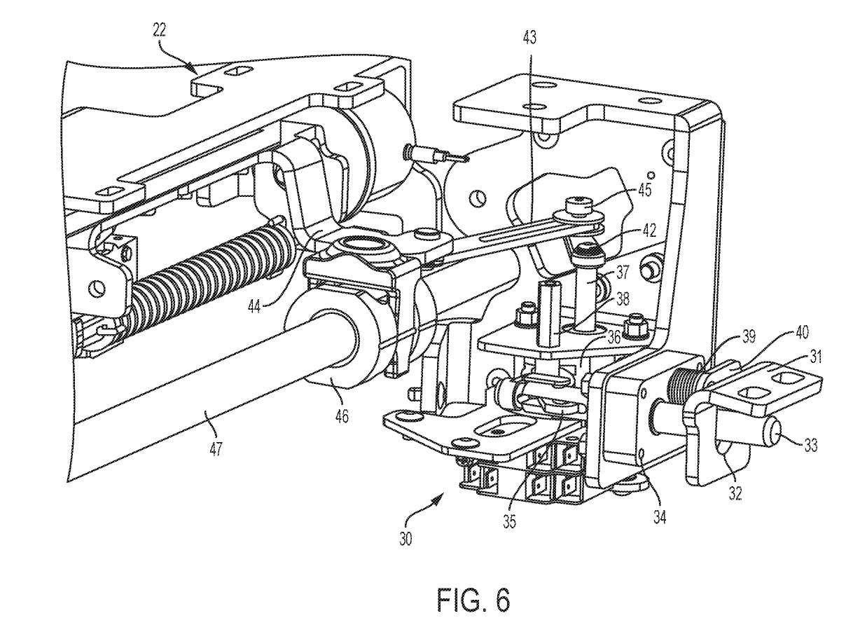

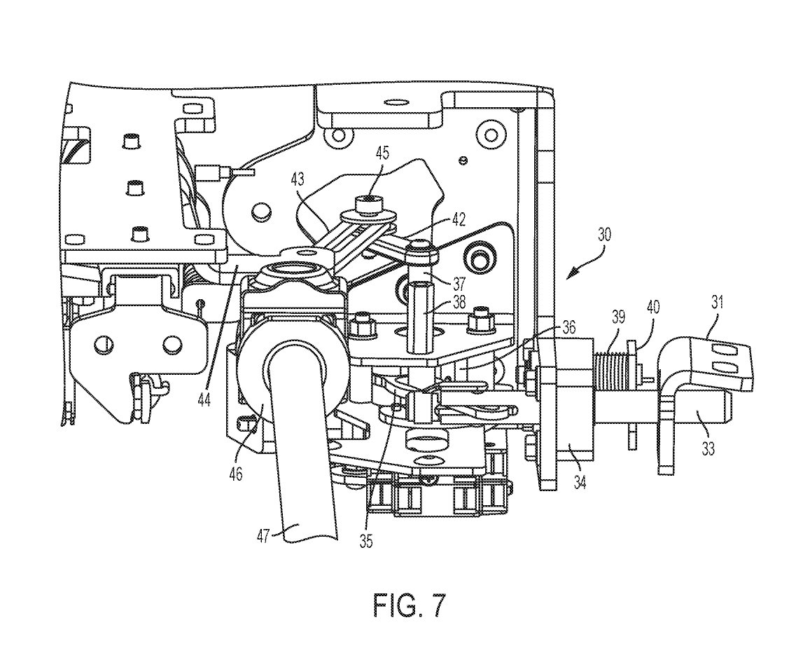

With reference to FIGS. 2-9, the isolation lock mechanism 30 for the door 12, 14 is shown according to an example of the present disclosure. The isolation lock mechanism includes a lock bracket 31 that is connected to the respective door 12, 14 such that the lock bracket 31 moves horizontally when the door 12, 14 moves between the open and closed positions. The lock bracket 31 includes a mortise hole 32 defined therein. The isolation lock mechanism 30 further includes a lock pin 33 configured to be moved between an engaged position, shown in FIGS. 6 and 7, in which the lock pin 33 is extended to engage the lock bracket 31, particularly within the mortise hole 32, and a disengaged position, shown in FIGS. 2-5, 8, and 9, in which the lock pin 33 is withdrawn from the lock bracket 31. The lock bracket 31 is suitably positioned on the door 12, 14 such that the mortise hole 32 of the lock bracket 31 is positioned concentric with the lock pin 33 when the door is in the closed position. In the engaged position, the lock pin 33 extends to engage the lock bracket 31, thereby preventing the door 12, 14 from opening. In the disengaged position, the lock pin 33 is withdrawn from the lock bracket 31 so that the door 12, 14 is free to move with operation of the door operator system 22.

As shown in FIGS. 2-9, the lock pin 33 is supported for linear movement between the engaged and disengaged positions by a journal bearing 34 attached to the structure of the door operator system 22. A linkage assembly 35, 36, 37, 38, 42, 43, 45 is connected to the lock pin 33 and is actuated to move the lock pin 33 between the engaged position and the disengaged position. The linkage assembly 35, 36, 37, 38, 42, 43, 45 is connected to an emergency release device 50 such that operation of the emergency release device 50 to unlock the door 12, 14 concurrently actuates the linkage assembly 35, 36, 37, 38, 42, 43, 45 to move the lock pin 33 from the engaged position to the disengaged position if the linkage assembly 35, 36, 37, 38, 42, 43, 45 is in the activated state, as will be discussed below.

In particular, as shown in FIGS. 2-9, the linkage assembly includes a slotted first arm 43 connected to the emergency release device. The slotted first arm 43 is directly connected to the mobile carrier 44 of the emergency release device 50. The linkage assembly further includes a second arm 42 connected to the first arm 43 by a linkage fastener 45 that engages the first arm 43 along the slot such that the linkage fastener 45, and thus the end of the second arm 42, is able to slide with respect to the slotted first arm 43. The opposite end of the second arm 42 is connected to a rotating shaft 37 that is rotatably supported on the structure of the isolation lock mechanism. A cam 36 is fixedly connected to the rotating shaft 37 so as to rotate with the rotating shaft 37 along the axis of the rotating shaft 37. A lever 35 is rotatably connected to the cam 36 concentric to the axis of the rotating shaft 37. The lever 35 is also rotatably connected to an end of the lock pin 33. A fixed shaft 38 is fixed to the structure of the isolation lock mechanism 30 and engages the central portion of the lever 35 to guide rotation of the lever 35.

The second arm 42 is connected to the slotted first arm 43 such that movement of the first arm 43 caused by linear movement of the mobile carrier 44 during operation of the emergency release device 50 causes the second arm 42 to rotate about a connection between the second arm 42 and the rotating shaft 37, which in turn causes rotation of the rotating shaft 37 and the cam 36. The rotation of the cam 36 causes rotation of the lever 35 about the fixed shaft 38. Rotation of the lever 35 causes a linear motion of the lock pin 33 between the engaged and disengaged positions.

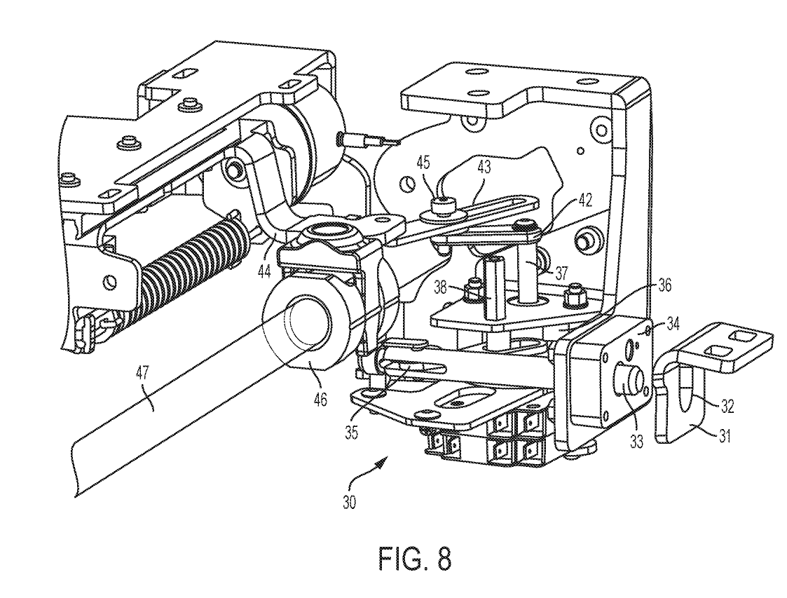

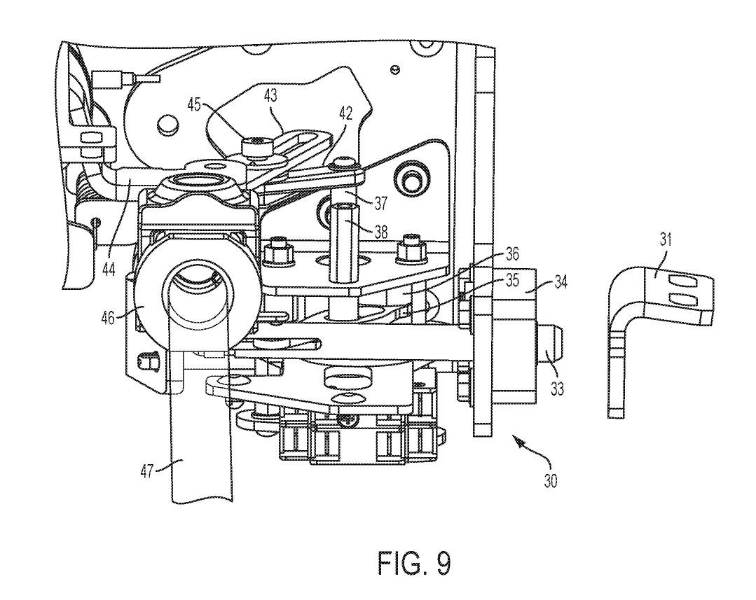

The rotating shaft 37 can be manually rotated by maintenance personnel using a crew key or similar device. Manual rotation of the rotating shaft 37 causes the second arm 42 and the linkage fastener 45 connecting the second arm 42 to the slotted first arm 43 to move with respect to the first arm 43 such that the linkage fastener 45 slides along the slot defined in the first arm 43. Accordingly, the linkage assembly can be switched between an activated state, in which the linkage fastener 45 engages an end of the slot on the first arm 43, as shown in FIGS. 2-7, such that operation of the emergency release device 50 actuates the linkage assembly to move the lock pin 33 between the engaged and disengaged positions, and a deactivated state, in which the linkage fastener 45 engages the slot of the first arm 43 away from the end, as shown in FIGS. 8 and 9, such that operation of the emergency release device 50 does not actuate the linkage assembly to move the lock pin 33.

As shown in FIGS. 2-4, 6, and 7, the journal bearing 34, which linearly supports the lock pin 33, includes a pivot shaft 39 that rotatably connects a mask plate 40 to the journal bearing 34. The mask plate 40 is pivotable on the pivot shaft 39 between a blocking position, shown in FIGS. 2-4, in which the mask plate 40 is disposed in a linear path of the lock pin to prevent the lock pin 33 from moving to the engaged position, and a releasing position, shown in FIGS. 6 and 7, in which the mask plate 40 is disposed away from the linear path of the lock pin 33 to allow the lock pin to move to the engaged position. According to one example, the pivot shaft 39 is configured such that the mask plate 40 is able to pivot about the pivot shaft 39 approximately 90°. The pivot shaft 39 may be spring-loaded such that the mask plate 40 is biased toward the blocking position. The mask plate 40 may include a bumper pin 41 that is engaged by an edge of the lock bracket 31 as the door 12, 14 enters the closed position such that the mask plate 40 is moved to the releasing position by the lock bracket 31, as shown in FIGS. 6 and 7.

With reference to FIGS. 2-5, the isolation lock mechanism 30 and the emergency release device are shown when the door 12, 14 is in the open position either during normal operation or because the emergency pull cable 48 has been manually actuated to pull the door 12, 14 open. The mobile carrier 44 and the drive nut 46 are advanced in the direction X thereby moving the slotted first arm 43, which may be directly connected to the mobile carrier 44, in the same direction with respect to the linkage fastener 45 and the end of the second arm 42 with the linkage fastener 45 engaging an end of the slot of the first arm 43 away from the mobile carrier 44. The linkage assembly is situated such that the lock pin 31 has been moved to the disengaged position. The mask plate 40 is disposed in the blocking position to prevent the lock pin 31 from being inadvertently moved to the engaged position while the door 12, 14 is still open.

With reference to FIGS. 6 and 7, the isolation lock mechanism 30 and the door operator system 22 are shown when the door 12, 14 is in the closed position and the linkage assembly is in the activated state. The condition of the isolation lock mechanism 30 illustrated in FIGS. 6 and 7 must be manually selected by rotating the rotating shaft 37 with a tool, such as a crew key, when the door 12, 14 is placed out of service during maintenance or repair. The rotating shaft 37 has been rotated such that the linkage fastener 45 and the end of the second arm 42 engage the end of the slot in the first arm 43 opposite to the mobile carrier 44 and such that the lever 35 has been rotated in a counterclockwise (viewed from the top) direction to linearly extend the lock pin 33 to the engaged position in which the lock pin 33 engages the mortise hole 32 defined in the lock bracket 31 to lock the door 12, 14 in the closed position. The lock bracket 31 has engaged the bumper pin 41 on the mask plate 40 to move the mask plate 40 to the releasing position, thereby freeing the lock pin to enter the engaged position.

When the linkage assembly is in the activated state, as shown, actuation of the emergency release cable 48 causes movement of the mobile carrier 44 and the drive nut 46 along the drive shaft 47 in the opening direction X, parallel to the plane of movement of the door 12, 14 to the open position. The movement of the mobile carrier 44 in this direction pulls on the slotted first arm 43, which in turn causes rotation of the second arm 42, the rotation shaft 37, and the cam 36, which causes the lever 35 to rotate clockwise (viewed from the top) about the fixed shaft 38 to move the lock pin 33 from the engaged position to the disengaged position.

Accordingly, actuation of the emergency release device 50 to open the door 12, 14 via the emergency release cable 48 when the linkage assembly is in the activated state will cause the linkage assembly 35, 36, 37, 38, 42, 43, 45 to move the lock pin 33 to the disengaged position. According to one example of the present disclosure, the door operator system 22 incorporates an overcenter locking mechanism, such as the overcenter locking mechanism described in Applicant's International Application No. PCT/US2017/026057. The actuation of the emergency release device 50 to open the door 12, 14 will also cause linear motion of the mobile carrier 44, which, in turn, will push on the drive nut 46 of the door operator system 22 to move in the X direction, to move the drive nut 46 to an unlocked position. A short distance of linear travel of the drive nut 46, such as a few centimeters, is required to unlock the overcenter locking mechanism. The isolation lock mechanism 30 may be arranged and connected to the emergency release device 50 in a manner that is synchronized with the overcenter locking mechanism of the door operator system 22 such that the motion of the mobile carrier 44 to cause the drive nut 46 to unlock the overcenter locking mechanism also causes the isolation lock mechanism 30 to move the lock pin 33 to the disengaged position, freeing the door 12, 14 to be moved to the open position. It is to be appreciated that the isolation lock mechanism 30 may be used in conjunction with any door operator system having a different overcenter locking mechanism or with no overcenter locking mechanism.

With reference to FIGS. 8 and 9, the isolation lock mechanism 30 and the door operator system 22 are shown when the door 12, 14 is in the closed position and the linkage assembly is in the deactivated state. The rotatable shaft 37 has been manually rotated such that the linkage fastener 45 and the end of the second arm 42 engage the slot of the first arm 43 proximate to the end of the first arm 43 where the first arm 43 engages the mobile carrier 44 and opposite to the end of the slot of the first arm 43 engaged by the linkage fastener 45 and the end of the second arm 42 when the linkage assembly is in the activated state shown in FIGS. 6 and 7. The mask plate 40, which is not illustrated in FIGS. 8 and 9 for clarity, is in the blocking position illustrated in FIGS. 2-4. In this position, linear movement of the mobile carrier 44 and the drive nut 46 in the X direction due to operation of the emergency release device 50 through manual actuation of the emergency pull cable 48, will pull on the first arm 43. The linkage fastener 45 and the end of the second arm 42 will stay at rest causing the first arm 43 to slide with respect to the linkage fastener 45 and the second arm 42 in engagement with the slot of the first arm 43. Accordingly, the second arm 42 will not be rotated by the movement of the first arm 43 and the lock pin 33 remains in the disengaged position.

Further examples of the present disclosure will now be described in the following number clauses.

Clause 1: An isolation lock mechanism (30) for a transit vehicle door (12), comprising: a lock bracket (31) configured to be connected to the transit vehicle door (12); a lock pin (33) configured to be moved between an engaged position in which the lock pin (33) is extended to engage the lock bracket (31) and a disengaged position in which the lock pin (33) is withdrawn from the lock bracket (31); and a linkage assembly (35, 36, 37, 38, 42, 43, 45) connected to the lock pin (33) and configured to be actuated to move the lock pin (33) between the engaged position and the disengaged position, wherein the linkage assembly (35, 36, 37, 38, 42, 43, 45) is configured to be connected to an emergency release device (50) such that operation of the emergency release device (50) actuates the linkage assembly (35, 36, 37, 38, 42, 43, 45) to move the lock pin (33) from the engaged position to the disengaged position.

Clause 2: The isolation lock mechanism (30) according to clause 1, wherein the linkage assembly (35, 36, 37, 38, 42, 43, 45) is configured to be switched between an activated state in which operation of the emergency release device (50) actuates the linkage assembly (35, 36, 37, 38, 42, 43, 45) and a deactivated state in which operation of the emergency release device (50) does not actuate the linkage assembly (35, 36, 37, 38, 42, 43, 45).

Clause 3: The isolation lock mechanism (30) according to clause 1 or clause 2, further comprising a journal bearing (34) that supports the lock pin (33) in a linear motion between the engaged position and the disengaged position.

Clause 4: The isolation lock mechanism (30) according to clause 3, further comprising a mask plate (40) and a pivot shaft (39) rotatably connecting the mask plate (40) to the journal bearing (34), wherein the mask plate (40) is pivotable on the pivot shaft (39) between a blocking position in which the mask plate (40) is disposed in a linear path of the lock pin (33) to prevent the lock pin (33) from moving to the engaged position and a releasing position in which the mask plate (40) is disposed away from the linear path of the lock pin (33).

Clause 5: The isolation lock mechanism (30) according to clause 4, wherein the mask plate (40) is biased toward the blocking position.

Clause 6: The isolation lock mechanism (30) according to clause 5, wherein the mask plate (40) comprises a bumper pin (41) configured to be engaged by the lock bracket (31) such that the mask plate (40) is moved to the releasing position by the lock bracket (31) as the transit vehicle door (12) moves to the closed position.

Clause 7: The isolation lock mechanism (30) according to any one of clauses 1-6, wherein the linkage assembly comprises: a first arm (43) configured to be connected to the emergency release device (50); a second arm (42) connected to the first arm (43); a rotating shaft (37) connected to the second arm (42); a cam (36) fixedly connected to the rotating shaft (37); and a lever (35) rotatably connected to the cam (36) and the lock pin (33), wherein the second arm (42) is connected to the first arm (43) such that movement of the first arm (43) due to operation of the emergency release device (50) causes the second arm (42) to rotate about a connection between the second arm (42) and the rotating shaft (37), which causes rotation of the rotating shaft (37) and the cam (36), wherein rotation of the cam (36) causes rotation of the lever (35), and wherein rotation of the lever (35) causes a linear motion of the lock pin (33) between the engaged and disengaged positions.

Clause 8: The isolation lock mechanism (30) according to clause 7, wherein the linkage assembly further comprises a fixed shaft (38), wherein the fixed shaft (38) engages the lever (35) to guide the rotation of the lever (35).

Clause 9: The isolation lock mechanism (30) according to clause 7 or clause 8, wherein the first arm (43) is slotted and is connected to the second arm (42) by a linkage fastener (45) configured to slide with respect to the slotted first arm (43).

Clause 10: The isolation lock mechanism (30) according to clause 9, wherein the linkage assembly is configured to be switched between an activated state in which the linkage fastener (45) engages an end of the slotted first arm (43) such that operation of the emergency release device (50) actuates the linkage assembly and a deactivated state in which the linkage fastener (45) engages the slotted first arm (43) away from the end such that operation of the emergency release device (50) does not actuate the linkage assembly.

Clause 11: A door assembly for a transit vehicle (10) having a door opening (18) formed in a wall (20) of the transit vehicle (10), the door assembly comprising: at least one door (12) disposed adjacent to the wall; a door operator system (22) configured to move the at least one door (12) along the door opening (18) between open and closed positions; an emergency release device (50) configured to manually unlock the door operator system (22); and an isolation lock mechanism (30), comprising: a lock bracket (31) connected to the at least one door (12); a lock pin (33) configured to be moved between an engaged position in which the lock pin (33) is extended to engage the lock bracket (31) and a disengaged position in which the lock pin (33) is withdrawn from the lock bracket (31); and a linkage assembly (35, 36, 37, 38, 42, 43, 45) connected to the lock pin (33) and configured to be actuated to move the lock pin (33) between the engaged position and the disengaged position, wherein the linkage assembly (35, 36, 37, 38, 42, 43, 45) is connected to the emergency release device (50) such that operation of the emergency release device (50) to unlock the at least one door (12) actuates the linkage assembly (35, 36, 37, 38, 42, 43, 45) to move the lock pin (33) from the engaged position to the disengaged position.

Clause 12: The door assembly according to clause 11, wherein the emergency release device (50) is configured to be manually actuated to cause the door operator system (22) to move the at least one door (12) to the open position.

Clause 13: The door assembly according to clause 11 or clause 12, wherein the linkage assembly (35, 36, 37, 38, 42, 43, 45) is configured to be switched between an activated state in which operation of the emergency release device (50) actuates the linkage assembly (35, 36, 37, 38, 42, 43, 45) and a deactivated state in which operation of the emergency release device (50) does not actuate the linkage assembly (35, 36, 37, 38, 42, 43, 45).

Clause 14: The door assembly according to any one of clauses 11-13, wherein the isolation lock mechanism (30) further comprises a journal bearing (34) that supports the lock pin (33) in a linear motion between the engaged position and the disengaged position.

Clause 15: The door assembly according to clause 14, wherein the isolation lock mechanism (30) further comprises a mask plate (40) and a pivot shaft (39) rotatably connecting the mask plate (40) to the journal bearing (34), wherein the mask plate (40) is pivotable on the pivot shaft (39) between a blocking position in which the mask plate (40) is disposed in a linear path of the lock pin (33) to prevent the lock pin (33) from moving to the disengaged position and a releasing position in which the mask plate (40) is disposed away from the linear path of the lock pin (33).

Clause 16: The door assembly according to any one of clauses 11-15, wherein the linkage assembly comprises: a first arm (43) connected to the emergency release device (50); a second arm (42) connected to the first arm (43); a rotating shaft (37) connected to the second arm (42); a cam (36) fixedly connected to the rotating shaft (37); and a lever (35) rotatably connected to the cam (36) and the lock pin (33), wherein the second arm (42) is connected to the first arm (43) such that movement of the first arm (43) due to operation of the emergency release device (50) causes the second arm (42) to rotate about a connection between the second arm (42) and the rotating shaft (37), which causes rotation of the rotating shaft (37) and the cam (36), wherein rotation of the cam (36) causes rotation of the lever (35), and wherein rotation of the lever (35) causes a linear motion of the lock pin (33) between the engaged and disengaged positions.

Clause 17: The door assembly according to clause 16, wherein the linkage assembly further comprises a fixed shaft (38), wherein the fixed shaft (38) engages the lever (35) to guide the rotation of the lever (35).

Clause 18: The door assembly according to clause 16 or clause 17, wherein the first arm (43) is slotted and is connected to the second arm (42) by a linkage fastener (45) configured to slide with respect to the slotted first arm (43), and wherein the linkage assembly is configured to be switched between an activated state in which the linkage fastener (45) engages an end of the slotted first arm (43) such that operation of the emergency release device (50) actuates the linkage assembly and a deactivated state in which the linkage fastener (45) engages the slotted first arm (43) away from the end such that operation of the emergency release device (50) does not actuate the linkage assembly.

Clause 19: The door assembly according to any one of clauses 16-18, wherein the first arm (43) is directly connected to a carrier (44) of the emergency release device (50).

Clause 20: The door assembly according to any one of clauses 11-19, wherein the door operator system (22) comprises an overcenter locking mechanism and actuation of the emergency release device (50) to unlock the overcenter locking mechanism of the door operator system (22) simultaneously actuates the isolation lock mechanism (30) to move the lock pin (33) to the disengaged position.

It is to be understood that the invention may assume various alternative variations and step sequences, except where expressly specified to the contrary. It is also to be understood that the specific devices and processes illustrated in the attached drawings, and described in the specification, are simply exemplary embodiments or aspects of the invention. Although the invention has been described in detail for the purpose of illustration based on what is currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope thereof. For example, it is to be understood that the present invention contemplates that, to the extent possible, one or more features of any embodiment or aspect can be combined with one or more features of any other embodiment or aspect.

The invention claimed is:

1. An isolation lock mechanism for a transit vehicle door, comprising:
a lock bracket configured to be connected to the transit vehicle door;
a lock pin configured to be moved between an engaged position in which the lock pin is extended to engage the lock bracket and a disengaged position in which the lock pin is withdrawn from the lock bracket; and
a linkage assembly connected to the lock pin and configured to be actuated to move the lock pin between the engaged position and the disengaged position,
wherein the linkage assembly is configured to be connected to an emergency release device such that operation of the emergency release device actuates the linkage assembly to move the lock pin from the engaged position to the disengaged position.

2. The isolation lock mechanism according to claim 1, wherein the linkage assembly is configured to be switched between an activated state in which operation of the emergency release device actuates the linkage assembly and a deactivated state in which operation of the emergency release device does not actuate the linkage assembly.

3. The isolation lock mechanism according to claim 1, further comprising a journal bearing that supports the lock pin in a linear motion between the engaged position and the disengaged position.

4. The isolation lock mechanism according to claim 3, further comprising a mask plate and a pivot shaft rotatably connecting the mask plate to the journal bearing,
wherein the mask plate is pivotable on the pivot shaft between a blocking position in which the mask plate is disposed in a linear path of the lock pin to prevent the lock pin from moving to the engaged position and a releasing position in which the mask plate is disposed away from the linear path of the lock pin.

5. The isolation lock mechanism according to claim 4, wherein the mask plate is biased toward the blocking position.

6. The isolation lock mechanism according to claim 5, wherein the mask plate comprises a bumper pin configured to be engaged by the lock bracket such that the mask plate is moved to the releasing position by the lock bracket as the transit vehicle door moves to the closed position.

7. The isolation lock mechanism according to claim 1, wherein the linkage assembly comprises:
a first arm configured to be connected to the emergency release device;
a second arm connected to the first arm;
a rotating shaft connected to the second arm;
a cam fixedly connected to the rotating shaft; and
a lever rotatably connected to the cam and the lock pin,
wherein the second arm is connected to the first arm such that movement of the first arm due to operation of the emergency release device causes the second arm to rotate about a connection between the second arm and the rotating shaft, which causes rotation of the rotating shaft and the cam,
wherein rotation of the cam causes rotation of the lever, and
wherein rotation of the lever causes a linear motion of the lock pin between the engaged and disengaged positions.

8. The isolation lock mechanism according to claim 7, wherein the linkage assembly further comprises a fixed shaft, wherein the fixed shaft engages the lever to guide the rotation of the lever.

9. The isolation lock mechanism according to claim 7, wherein the first arm is slotted and is connected to the second arm by a linkage fastener configured to slide with respect to the slotted first arm.

10. The isolation lock mechanism according to claim 9, wherein the linkage assembly is configured to be switched between an activated state in which the linkage fastener engages an end of the slotted first arm such that operation of the emergency release device actuates the linkage assembly and a deactivated state in which the linkage fastener engages the slotted first arm away from the end such that operation of the emergency release device does not actuate the linkage assembly.

11. A door assembly for a transit vehicle having a door opening formed in a wall of the transit vehicle, the door assembly comprising:
at least one door disposed adjacent to the wall;
a door operator system configured to move the at least one door along the door opening between open and closed positions;
an emergency release device configured to manually unlock the door operator system; and
an isolation lock mechanism, comprising:
a lock bracket connected to the at least one door;
a lock pin configured to be moved between an engaged position in which the lock pin is extended to engage the lock bracket and a disengaged position in which the lock pin is withdrawn from the lock bracket; and
a linkage assembly connected to the lock pin and configured to be actuated to move the lock pin between the engaged position and the disengaged position,
wherein the linkage assembly is connected to the emergency release device such that operation of the emergency release device to unlock the at least one door actuates the linkage assembly to move the lock pin from the engaged position to the disengaged position.

12. The door assembly according to claim 11, wherein the emergency release device is further configured to be manually actuated to cause the door operator system to move the at least one door to the open position.

13. The door assembly according to claim 11, wherein the linkage assembly is configured to be switched between an activated state in which operation of the emergency release device actuates the linkage assembly and a deactivated state in which operation of the emergency release device does not actuate the linkage assembly.

14. The door assembly according to claim 11, wherein the isolation lock mechanism further comprises a journal bearing that supports the lock pin in a linear motion between the engaged position and the disengaged position.

15. The door assembly according to claim 14, wherein the isolation lock mechanism further comprises a mask plate and a pivot shaft rotatably connecting the mask plate to the journal bearing,
wherein the mask plate is pivotable on the pivot shaft between a blocking position in which the mask plate is disposed in a linear path of the lock pin to prevent the lock pin from moving to the disengaged position and a releasing position in which the mask plate is disposed away from the linear path of the lock pin.

16. The door assembly according to claim 11, wherein the linkage assembly comprises:
a first arm connected to the emergency release device;
a second arm connected to the first arm;
a rotating shaft connected to the second arm;
a cam fixedly connected to the rotating shaft; and
a lever rotatably connected to the cam and the lock pin,
wherein the second arm is connected to the first arm such that movement of the first arm due to operation of the emergency release device causes the second arm to rotate about a connection between the second arm and the rotating shaft, which causes rotation of the rotating shaft and the cam,
wherein rotation of the cam causes rotation of the lever, and
wherein rotation of the lever causes a linear motion of the lock pin between the engaged and disengaged positions.

17. The door assembly according to claim 16, wherein the linkage assembly further comprises a fixed shaft, wherein the fixed shaft engages the lever to guide the rotation of the lever.

18. The door assembly according to claim 16, wherein the first arm is slotted and is connected to the second arm by a linkage fastener configured to slide with respect to the slotted first arm, and
wherein the linkage assembly is configured to be switched between an activated state in which the linkage fastener engages an end of the slotted first arm such that operation of the emergency release device actuates the linkage assembly and a deactivated state in which the linkage fastener engages the slotted first arm away from the end such that operation of the emergency release device does not actuate the linkage assembly.

19. The door assembly according to claim 16, wherein the first arm is directly connected to a carrier of the emergency release device.

20. The door assembly according to claim 11, wherein the door operator system comprises an overcenter locking mechanism and actuation of the emergency release device to unlock the overcenter locking mechanism of the door operator system simultaneously actuates the isolation lock mechanism to move the lock pin to the disengaged position.
